(19) United States
(12) Patent Application Publication
(10) Pub. No.: US 2018/0242084 A1
(43) Pub. Date: Aug. 23, 2018

(54) VARIABLE SHAPE SURROUND DEVICE FOR A HIGH EXCURSION SPEAKER DRIVE

(71) Applicant: Jacob Aaron FULLER, Claremont, NC (US)

(72) Inventor: Jacob Aaron FULLER, Claremont, NC (US)

(21) Appl. No.: 15/899,690

(22) Filed: Feb. 20, 2018

Related U.S. Application Data
(60) Provisional application No. 62/460,991, filed on Feb. 20, 2017.

(51) Int. Cl. H04R 5/02; H04R 1/02

(52) U.S. Cl. CPC H04R 5/02; H04R 1/02

(57) ABSTRACT

The present invention provides methods and systems for a surround device that includes a generally circular arcuate portion that contains a first side and a second side, a first planar portion extends from the first side and a second planar portion extends from the second side, a plurality of outwardly facing ribs are disposed on the first side, and a plurality of inwardly facing ribs are disposed on the second side.

### CROSS REFERENCE TO RELATED PATENT APPLICATION

The present patent application/patent claims the benefit of priority of co-pending U.S. Provisional Patent Application No. 62/460,991, filed on Feb. 20, 2017, and entitled “Variable Shape Surround For A High Excursion Speaker Drive,” the contents of which are incorporated in full by reference herein.

### FIELD OF THE INVENTION

The present invention relates generally to a generally circular surround for an increased stiffening effect, and more generally relates to a generally circular surround that contains a plurality of ribs disposed on the surround for increasing the stiffening effect towards the displacement limits.

### BRIEF SUMMARY OF THE INVENTION

According to an embodiment of the present invention, a surround device that includes a generally circular arcuate portion that contains a first side and a second side, a first planar portion extends from the first side and a second planar portion extends from the second side, a plurality of outwardly facing ribs are disposed on the first side, and a plurality of inwardly facing ribs are disposed on the second side.

According to another embodiment of the present invention, the surround device includes a center portion of the arcuate portion that does not contain any ribs for creating a linear displacement range.

According to yet another embodiment of the present invention, the surround device is composed of Santoprene.

According to yet another embodiment of the present invention, the surround device has ribs with a length of between about 70 mm and about 1 mm and a width between about 40 mm and about 1 mm.

According to yet another embodiment of the present invention, the surround device has ribs with a length of between about 50 mm and about 10 mm and a width of between about 20 mm and about 5 mm.

According to yet another embodiment of the present invention, the surround device has ribs with a length of between about 30 mm to about 20 mm and a width of about 15 mm to about 10 mm.

According to yet another embodiment of the present invention, the surround device has a first planar portion that extends outwardly and forms an angle between an exterior surface of the first planar portion and an exterior surface of the first side of about 90° to about 120°.

According to yet another embodiment of the present invention, the surround device has a second planar portion that extends outwardly and forms an angle between an interior surface of the second planar portion and a plane extending horizontally under the surround device of about 95° to about 150°.

According to yet another embodiment of the present invention, the surround device has a top portion, a first side extending downwardly from the top portion, a second side extending downwardly from the top portion and opposite the direction of the first side, and a trough formed between the first side, the second side, and the top portion. A first planar portion extends outwardly from the first side to an outer edge and a second planar portion extends outwardly from the second side to an outer edge. A plurality of outwardly facing ribs is disposed along the first side and a plurality of inwardly facing ribs is disposed along the second side.

According to yet another embodiment of the present invention, the surround device includes outwardly spacing ribs are spaced-apart an equal distance along an exterior of the first side.

According to yet another embodiment of the present invention, the surround device includes inwardly facing ribs are spaced-apart an equal distance along the exterior side of the second side.

According to yet another embodiment of the present invention, the surround device includes outwardly facing ribs have a front side and a back side and the width of the outwardly facing rib decreases along the length of the outwardly facing rib from the front side to the back side.

According to yet another embodiment of the present invention, the surround device includes inwardly facing ribs have a front side and a back side and the width of the inwardly facing rib gradually increases along the length from the front side to a central portion of the inwardly facing rib and then gradually decreases along the length from the central portion to the back side.

According to yet another embodiment of the present invention, the surround device is generally circular and the center of the surround device is a void.

According to yet another embodiment of the present invention, the surround device includes a top portion, a first side extending downwardly from the top portion and having an interior side and an exterior side, and a second side extending downwardly from the top portion and opposite the direction of the first side and having an interior side and an exterior side. A trough is formed within the interior of the first side, the second side, and the top portion. A first planar portion extends outwardly from the first side to an outer edge, and a second planar portion extends outwardly from the second side to an outer edge. A plurality of outwardly facing ribs are disposed along the first side, and a plurality of inwardly facing ribs disposed on along the second side.

According to yet another embodiment of the present invention, the surround device includes an outwardly facing rib disposed on the first planar portion.

According to yet another embodiment of the present invention, the surround device includes an outwardly facing rib with a width of between about 12 mm to about 14 mm.

According to yet another embodiment of the present invention, the surround device includes a inwardly facing rib that has a width of between about 12 mm to about 15 mm.

### BRIEF DESCRIPTION OF THE DRAWINGS

The present invention is illustrated and described herein with reference to the various drawings, in which like reference numbers denote like method steps and/or system components, respectively, and in which:

FIG. 1 is a top view of the present invention;

FIG. 2 is a cross-section of the surround of the present invention along the line A-A- of FIG. 1;

FIG. 3 is a perspective view of the present invention;

FIG. 4 is a side view of the present invention;

FIG. 5 is a cut-away side view of the present invention; and

FIG. 6 is a table showing the effect of a surround with ribs and without ribs.

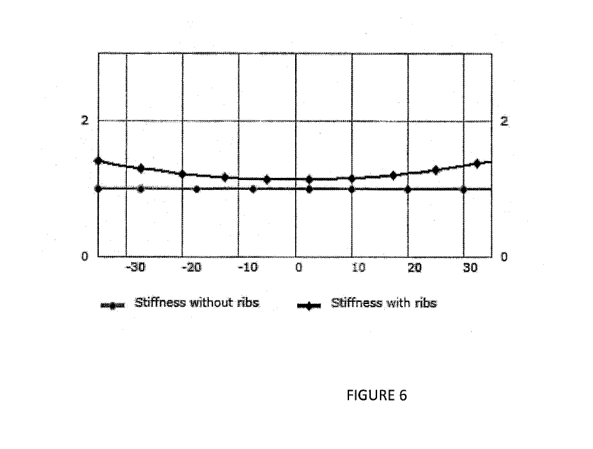

### DETAILED DESCRIPTION OF THE INVENTION

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

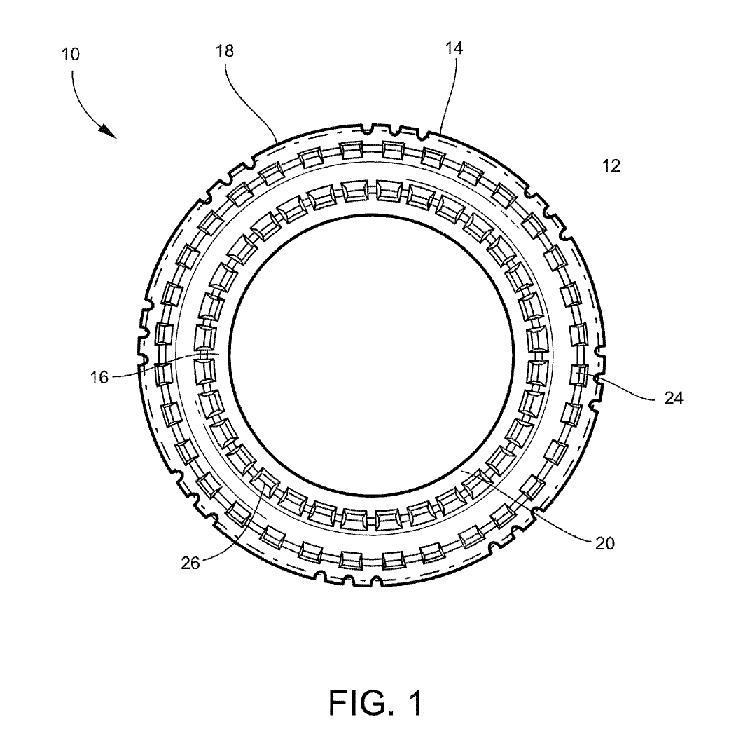

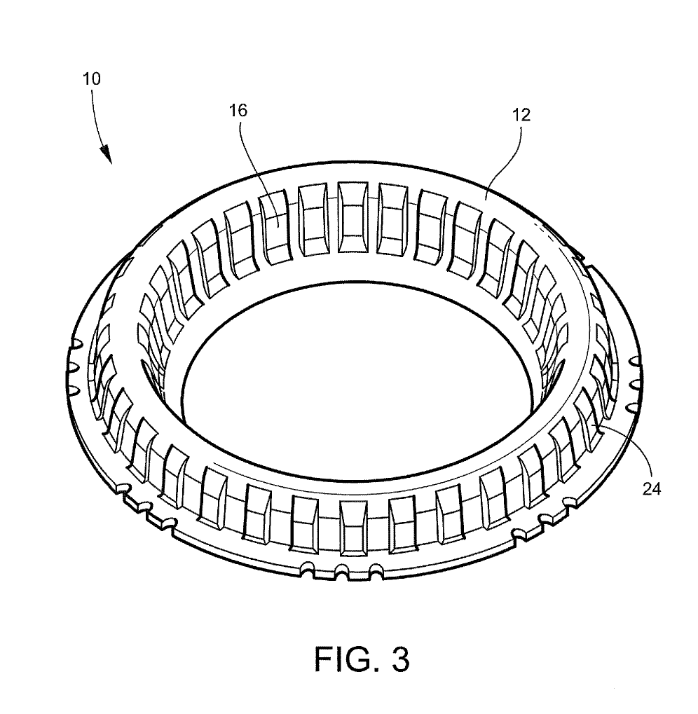

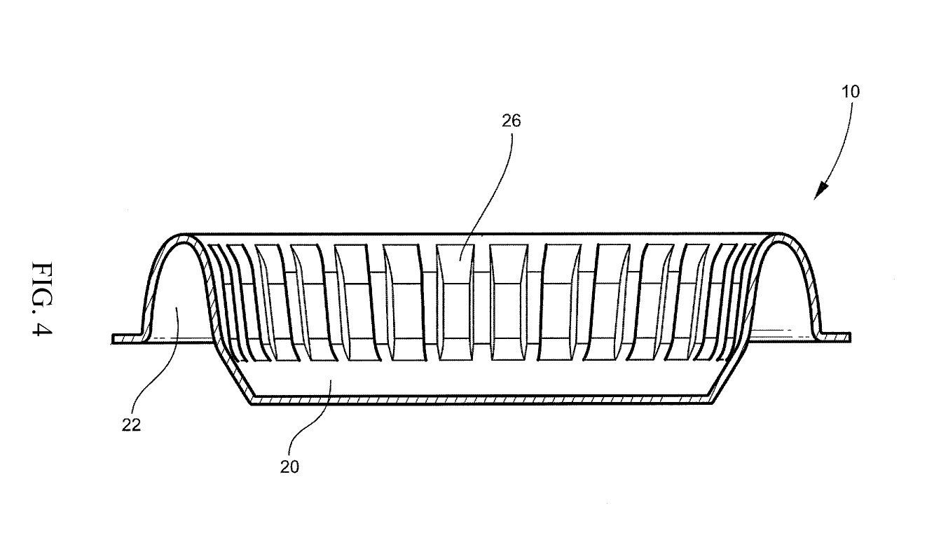

Referring now specifically to the drawings, a surround device is illustrated in FIGS. 1-5 and is shown generally at reference numeral 10. The surround device 10 has a three-dimensional shape to provide an increased stiffening effect towards the displacement limits while maintaining linear force/displacement behavior during low and medium amplitude displacement. The 3D shape also allows for or has the additional effect of reduced instability due to buckling effect on large displacement.

The surround device 10 is generally circular and contains a void in the center. In other words, the center portion of the surround device 10 has a hollow center portion that does not contain any portion of the surround device 10. The surround device 10 contains a generally arcuate center portion 12 having a first side 14 and a second side 16 that extends downward from opposite directions to a first planar portion 18 and a second planar portion 20. The arcuate center portion 12 contains an exterior surface and an interior surface. The surround device 10 has a top portion with a first side 14 that extends downward from one direction and a second side 16 that extends downward from the opposite direction forming a trough 22 with the interior surface of the top portion and first side 14 and second side 16. The first planar portion 18 extends outwardly from the first side 14 to an outer edge, and the second planar portion 20 extends outwardly from the second side 16 to an outer edge. A plurality of outwardly facing ribs 24 and a plurality of inwardly facing ribs 26 are positioned along the exterior surface of the first side 14 and the second side 16 of the arcuate center portion 12 to provide the desired effect of the surround 10. The inwardly facing ribs 26 face towards the void or center 2 of the surround device 10. The outwardly facing ribs 24 face outwards to the exterior area around the surround device 10.

The profile of the surround device 10 is generally arcuate shaped or having an axis of symmetrical shape that can be in the shape of a segment of a circle or any other, including accordion-shaped wave, elliptical, “tall-roll” or any shape that allows for symmetrical movement on a direction while restraining movement on the orthogonal directions. The top portion of the arcuate center portion 12, or the area where the upper portion of the first side 14 and the second side 16 intersect or become one, is free of ribs for creating the linear displacement range.

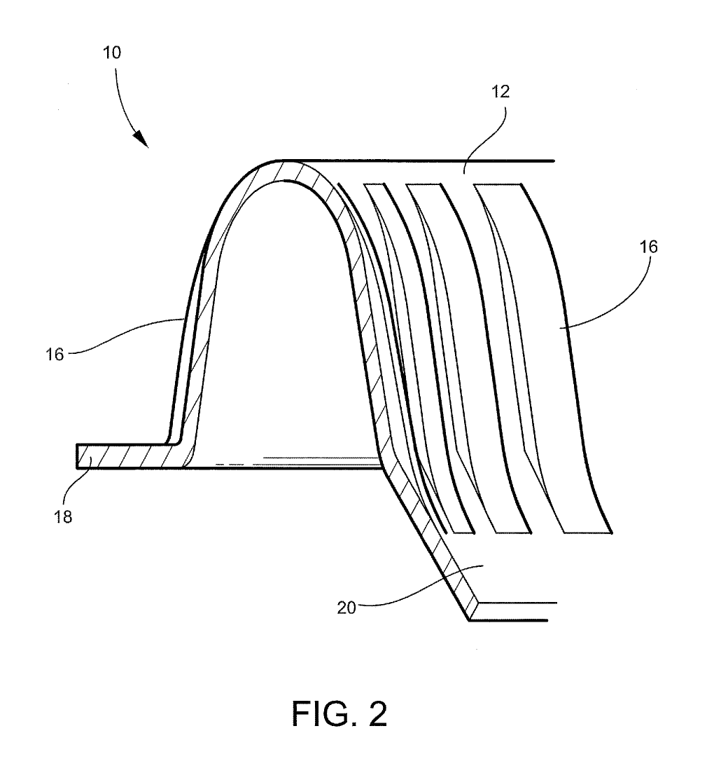

The outwardly facing ribs 24 have a front side, a back side, a left side, and a right side. The front side is positioned adjacent the first planar portion 18 and extends upwards along the first side 14 to the arcuate center portion 12 to the back side. The height of the rib 24 decreases from the front side to the back side of the outwardly facing rib 24. The decrease in height is gradual along the length of the rib 18 having the greatest height at the front side and decreasing to zero or no height at the back side, as shown in FIG. 2. The outwardly facing ribs 24 generally have a rectangularly shape. A plurality of outwardly facing ribs 24 are spaced around the entire surround device 10 in a spaced-apart arrangement.

The inwardly facing rib 26 has a different configuration than that of the outwardly facing rib 24. Like the outwardly facing rib 24, the inwardly facing rib 26 has a front side, a back side, a left side, and a right side. The front side is positioned adjacent the second planar portion 20 and extends upwards to the arcuate center portion 12 to the back side of the inwardly facing rib 26. The height of the inwardly facing rib 26 is greatest in its central portion disposed between the front side and the back side. The height gradually increases along the length of the rib from the front side, stays constant towards the center portion of the inwardly facing rib 26, and gradually decreases towards the back end to zero or no height. The inwardly facing ribs generally have a rectangularly shape. A plurality of inwardly facing ribs 26 are spaced around the entire surround device 10 in a spaced-apart arrangement. The first side of the inwardly facing rib 26 is positioned on the second planar portion 20 and extends onto the second side 16 along the length of the inwardly facing rib 26 to the back side that is disposed on the second side 16 of the surround device 10, as illustrated in FIG. 2.

During production, the surround device 10 may be injection molded or formed from any other known method. Preferably, the surround device 10 is composed of Santoprene, but can be composed of any other rubber or thermoplastic elastomer material.

The length of the ribs (24,26) may have a length of between about 70 mm and about 1 mm and a height between about 40 mm and about 1 mm, more preferably a length of between about 50 mm and about 10 mm and a height of between about 20 mm and about 5 mm, and most preferably a length of between about 30 mm to about 20 mm and a height of about 15 mm to about 10 mm, including all points in-between.

The surround device 10 has a thickness between about 0.1 mm to about 4 mm and preferably from about 0.5 mm to about 2.5 mm at the locations that do not contain ribs (24,26).

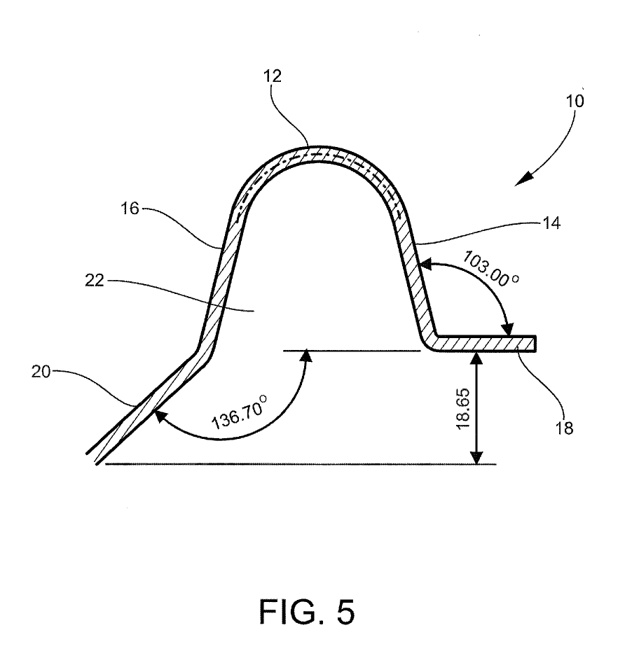

The first planar portion 18 extends outwardly from a first end of the first side 14. The first planar portion 18 extends outwardly and forms an angle between the exterior surface of the first planar portion 18 and the exterior surface of the first side 14 of about 90° to about 120°, and more preferably between about 95° and about 110°, and most preferably an angle of 103°. The second planar portion 20 extends outwardly from a first end of the second side 16. The second planar portion 20 extends outwardly and forms an angle between the interior surface of the second planar portion 20 and a plane extending horizontally under the surround device 10, as shown in FIG. 5 of about 95° to about 150° and preferably from about 125° to about 140°, and most preferably an angle of 136.7°.

The outwardly facing rib 24 has a width of about 10 mm to about 17 mm, and preferably from about 12 mm to about 14 mm, and most preferably from about 12 mm to about 14 mm. The inwardly facing rib 26 has a width of about 10 mm to about 18 mm, and preferably between about 12 mm to about 17 mm, and most preferably from about 13 mm to about 15 mm.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are intended to be covered by the following claims.

What is claimed is:

1. A surround device comprising:
a generally circular arcuate portion that contains a first side and a second side;
a first planar portion extends from the first side and a second planar portion extends from the second side;
a plurality of outwardly facing ribs are disposed on the first side; and
a plurality of inwardly facing ribs are disposed on the second side.

2. The surround device according to claim 1, wherein the center portion of the arcuate portion does not contain any ribs.

3. The surround device according to claim 1, wherein the surround is composed of Santoprene.

4. The surround device according to claim 1, wherein the ribs have a length of between about 70 mm and about 1 mm and a width between about 40 mm and about 1 mm.

5. The surround device according to claim 1, wherein the ribs have a length of between about 50 mm and about 10 mm and a width of between about 20 mm and about 5 mm.

6. The surround device according to claim 1, wherein the ribs have a length of between about 30 mm to about 20 mm and a width of about 15 mm to about 10 mm.

7. The surround device according to claim 1, wherein the first planar portion extends outwardly and forms an angle between an exterior surface of the first planar portion and an exterior surface of the first side of about 90° to about 120°.

8. The surround device according to claim 1, wherein the second planar portion extends outwardly and forms an angle between an interior surface of the second planar portion and a plane extending horizontally under the surround device of about 95° to about 150°.

9. A surround device comprising:
a top portion;
a first side extending downwardly from the top portion;
a second side extending downwardly from the top portion and opposite the direction of the first side;
a trough formed between the first side, second side, and top portion;
a first planar portion that extends outwardly from the first side to an outer edge;
a second planar portion that extends outwardly from the second side to an outer edge;
a plurality of outwardly facing ribs disposed along the first side; and
a plurality of inwardly facing ribs disposed on along the second side.

10. The surround device according to claim 9, wherein the outwardly facing ribs are spaced-apart an equal distance along an exterior side of the first side.

11. The surround device according to claim 9, wherein the inwardly facing ribs are spaced-apart an equal distance along an exterior side of the second side.

12. The surround device according to claim 9, wherein the outwardly facing ribs have a front side and a back side, the width of the outwardly facing rib decreases along the length of the outwardly facing rib from the front side to the back side.

13. The surround device according to claim 9, wherein the inwardly facing ribs have a front side and a back side, the width of the inwardly facing ribs gradually increases along the length from the front side to a central portion of the inwardly facing ribs and then gradually decreases along the length from the central portion to the back side.

14. The surround device according to claim 9, wherein the surround device is generally circular and the center of the surround device contains a void.

15. A circular surround device comprising:
a top portion;
a first side extending downwardly from the top portion and having an interior side and an exterior side;
a second side extending downwardly from the top portion and opposite the direction of the first side and having an interior side and an exterior side;
a trough formed within the interior of the first side, the second side, and the top portion;
a first planar portion that extends outwardly from the first side to an outer edge;
a second planar portion that extends outwardly from the second side to an outer edge;
a plurality of outwardly facing ribs disposed along the first side; and
a plurality of inwardly facing ribs disposed on along the second side.

16. The circular surround device according to claim 15, wherein the surround device is composed of Santoprene.

17. The circular surround device according to claim 15, wherein the top portion does not contain any ribs for creating a linear displacement range.

18. The circular surround device according to claim 15, wherein a front side of the outwardly facing rib is disposed on the first planar portion.

19. The circular surround device according to claim 15, wherein the outwardly facing rib has a width of between about 12 mm to about 14 mm.

20. The circular surround device according to claim 15, wherein the inwardly facing rib has a width of between about 12 mm to about 15 mm.
